(19) United States
(12) Patent Application Publication
(10) Pub. No.: US 2005/0125363 A1
(43) Pub. Date: Jun. 9, 2005

(54) System and method for authorizing transactions

(76) Inventors: Charles E. Wilson, Simi Valley, CA (US); Walter W. Mosher, West Hills, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/964,562

(22) Filed: Oct. 12, 2004

Related U.S. Application Data
(60) Provisional application No. 60/512,312, filed on Oct. 16, 2003.

(51) Int. Cl. G06F 17/60

(52) U.S. Cl. 705/75

(57) ABSTRACT

Methods and systems for authorizing and automating transactions, such as the sale of alcoholic beverages, are provided. In one embodiment, data is entered from a customer's driver's license into a computer database, and a record that is associated with the customer is created in the database. A wristband is processed through a computer printer so that information associated with the person is placed on the wristband. This information is read at a point-of-service (POS) station and compared with the data in the database to determine whether to authorize the sale of an alcoholic beverage to the customer.

### RELATED APPLICATION

This application claims priority to U.S. Provisional Application Ser. No. 60/512,312, filed on Oct. 16, 2003.

### BACKGROUND OF THE INVENTION

The present invention generally relates to systems and methods for authorizing transactions. More particularly, the present invention is related to a system utilizing an identification wrist band coded with information to identify the individual or the individual's age, and preferably linked to a database for linking that individual with other individuals or information, such as a financial account which can be debited so as not to require the exchange of money for a financial transaction.

Identification devices, such as cards, frequently are used to identify an individual for purposes of authorizing a transaction. They are used, for example, to confirm the age of the individual in order to determine whether a sale of alcohol may be made in those jurisdictions having age-related restrictions for such transactions. Common and convenient identification devices include credit cards, debit cards, employee identification cards, student identification cards, as well as government issued items such as driver's licenses, passports, social security cards, voter's registration cards, military identification cards and immigration cards. Another example of an identification device is a smart card, which contains a memory provided by an embedded integrated circuit.

These devices can provide statistical information regarding the authorized bearer of the device in at least one machine-readable medium such as a barcode or a magnetic stripe. Many identifying documents or devices have more than one machine-readable medium for storing identifying information. For example, a driver's license typically includes a photograph, printed textual information and visible encoded information, such as a barcode. In some cases a magnetic stripe provides a higher level of security and additional information regarding the bearer. The information stored in the magnetic stripe of a driver's license may include identifying information about the authorized bearer, such as eye color, hair color, height, weight, other biometric characteristics, etc. Examples of other biometric characteristics can include digital data of the bearer's fingerprint, knuckle print, palm print, deoxyribonucleic acid (DNA) profile, etc. The identifying information can further include eye patterns indicative of the iris or retina of the individual. The barcode and magnetic stripe may also include data related to ascertaining the age of the bearer. Alternatively, the above information may be stored in the memory of an embedded integrated circuit on a smart card.

In the case of transactions involving the sale of alcohol where age identification is desired, point of service (“POS”) and other ID-related locations have relied upon manual input of identification data, visual or read-only identifiers, and unlinked issuance and POS stations. The manual inputting of data input can frequently be the cause of errors in prior systems. At that time, the customer or patron is misidentified in a variety of ways, ranging from unintentional error by the recording personnel (e.g., miscalculated age based on the date of birth) to deception by the person providing the information. (e.g., a false driver's license) Read-only identifiers have the major disadvantage of inflexibility in that errors often cannot be corrected, and new information cannot be added to the identifier.

Accordingly, there is a continuing need for a system and method for authorizing transactions, and particularly transactions involving the sale of alcohol where age identification is desired. Such a system and method should eliminate the manual inputting of data to the extent possible, and preferably incorporate two-way communication devices, such as RFID wristbands and the like. The present invention fulfills these needs and provides other related advantages.

### SUMMARY OF THE INVENTION

A method and system for authorizing a transaction, such as for example the providing of an alcoholic beverage, is provided.

In one aspect, a person having an identification device containing a first set of data associated with the person presents the identification device at a first station located on a premises. The first set of data from the identification device is inputted into a computer database. A new record associated with the person is created in the database. An information device, such as for example a wristband, is adapted to convey a second set of data associated with the person. One example of adapting the wristband is to print an image onto the band by processing it through a printer. The information device is then provided to the person.

When the person desires to conduct a transaction at a second station located on the premises, the information device is presented to the second station where the second set of data is read from the information device. At least a part of the second set of data is used to determine whether a transaction criteria has been satisfied. The transaction with the person is permitted at the second station after determining that the transaction criteria has been satisfied.

In another aspect, the information device includes a RFID device having at least a part of the second set of data residing within the RFID device. The step of adapting the information device includes writing at least a part of the second set of data to the RFID device.

In an alternative embodiment, a person having an identification device containing a first set of data associated with the person presents the identification device at a first station. The first set of data is inputted from the identification device into a computer database. A determination is made whether a pre-existing record associated with the person exists in the database. A new record associated with the person is created in the database after determining that no pre-existing record exists. A payment amount received from the person is entered into the database to create an account having an account balance.

A wristband is adapted to convey a second set of data associated with the person by using a printer in communication with a computer to print an image on the wristband, where the image is associated with at least a part of the second set of data. Examples of the image can include text or a barcode or both. The wristband is then secured onto the wrist of the person.

When the person desires to obtain an alcoholic beverage at a second station, the wristband is presented to the second station. At least a portion of the second set of data is read from the wristband with an automatic reader located at the second station and in communication with the database. At least a portion of the second set of data is used to determine whether the person satisfies an age criteria. An alcoholic beverage having a cost is provided to the person after determining that the person satisfies the age criteria and that the cost of the alcoholic beverage does not exceed the account balance. A third set of data associated with the providing of the alcoholic beverage to the person is entered into the database. Such data may include the date and time that the beverage was provided, the type of beverage provided, and the cost associated with the beverage.

In another aspect, the wristband includes a RFID device having at least a part of the second set of data residing within the RFID device. The step of adapting the wristband includes writing at least a part of the second set of data to the RFID device.

In an alternative embodiment, a method of controlling the exit of a first person from a premises unless accompanied by an approved second person is provided. One example might be a child who is accompanied by an adult, such as a parent. A record set of data is entered in a computer database. First and second information devices, such as for example wristbands, are adapted to convey a first and second set of data, respectively, after the step of entering the record set of data in the computer database. One example of this adaptation would be to print images onto wristbands by processing them through a printer.

Later, at a point of egress from the premises, the first set of data is read from the first information device being carried by the child, and the second set of data is read from the second information device being carried by an adult. The first and second sets of data are compared with the record set of data. The child is permitted to exit the premises when the first and second sets of data correspond to the record set of data thereby indicating that the child and adult were in the company of one another during the steps of adapting the first and second information devices to convey the first and second sets of data. If the first and second sets of data do not correspond to the record set of data, then the child is not permitted to exit the premises without further investigation.

In another aspect, the first and second information devices each includes a first and a second RFID device, respectively. The step of adapting the first information device further includes writing the first set of data to the first RFID device, and the step of adapting the second information device further includes writing the second set of data to the second RFID device.

In another embodiment of the present invention, the information device contains sufficient information about the individual such that when it is scanned or otherwise read, it communicates the necessary information regarding the individual so as to provide the information necessary to complete an electronic form, such as a medical form, airport form, etc. The identity of the individual and/or the filled-out form can be displayed on a computer display unit associated with the reader.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 illustrates a block diagram overview of the general architecture of a system for authorizing a transaction according to an embodiment of the present invention;

FIG. 2a illustrates a wristband for use in an embodiment of the present invention;

FIG. 2b illustrates the reverse side of the wristband of FIG. 2a;

FIG. 3a illustrates a wristband for use in another embodiment of the present invention;

FIGS. 3b and 3c illustrate a pair of wristbands for use in another embodiment of the present invention;

FIG. 4a illustrates a wristband for use in another embodiment of the present invention;

FIGS. 4b and 4c illustrate a pair of wristbands for use in another embodiment of the present invention;

FIG. 5 illustrates a flowchart of a method for authorizing a transaction according to another embodiment of the invention;

FIG. 6 illustrates a flowchart of a method for authorizing a transaction according to another embodiment of the invention; and

FIG. 7 illustrates a flowchart of a method for authorizing a transaction according to another embodiment of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

One embodiment of the invention addresses the problem of identifying underage drinkers and preventing them from purchasing alcoholic beverages from vendors at public or private auditoriums, sports arenas, stadiums, concert venues, amusement parks, casino bars and other controlled public or private environments or premises. Moreover, the quantity of alcohol consumption can be controlled. The system can be configured to account for all alcoholic beverages purchased, provide a guideline blood-alcohol calculation, and limit a consumer's purchases to within safe limits that can discourage or help prevent excessive consumption.

The system further can be configured to allow for pre-payment of beverages sold within the premises thereby providing a “cashless” or “credit” transaction system. A database of consumer purchasing statistics is maintained and includes an account reflecting the pre-payment or credit amount associated with a patron and the automatic updating of this information as beverages are later obtained throughout the patron's stay at the premises.

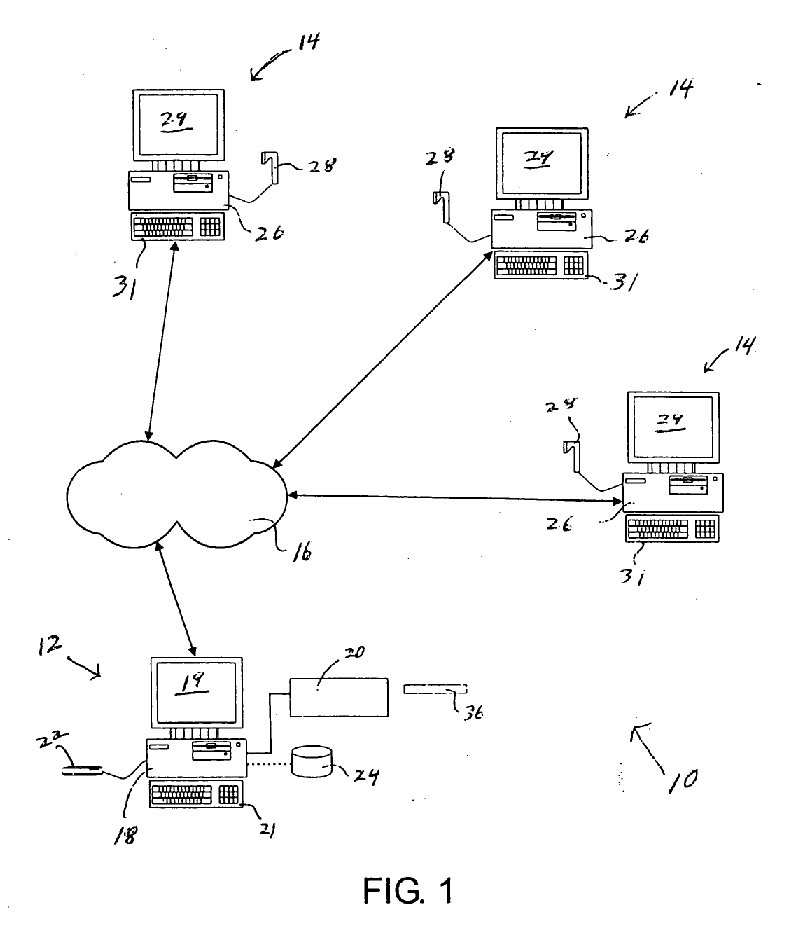

With reference now to FIG. 1, there is illustrated a computerized transaction authorization system 10 according to one embodiment of the invention. The transaction authorization system 10 includes a wristband 36, a master transaction station 12 and a plurality of client transaction stations 14, each of which is in communication with the master transaction station 12 via a local area network (LAN) 16. Alternatively, communication can be established over a wide area network (WAN), the Internet, or a wireless network, such as for example, a Bluetooth wireless network.

The master transaction station 12 includes a computer 18 that is in communication with a printer 20 and a reader 22. The computer 18 has a display 19 and a keyboard 21 and further includes a database 24 for the creation, storage and use of information relating to transactions. Although the database 24 of FIG. 1 is part of the master transaction station computer 18, alternative embodiments can include one or more databases that reside in other computers that are either locally or remotely situated and that are accessible to the master transaction station 12 or to the client stations 14 via the LAN 16 or via a WAN, a wireless network or the Internet.

Each of the client transaction stations 14 includes a client computer 26 having a display 29 and keyboard 31 and being in communication with a client reader 28. The client computers 26 and the master transaction station computer 18 can be general-purpose computers, specialized computers, point of sale (POS) computers or terminals that are networked to one or more central computers, etc. The master transaction station reader 22 is adapted to read information by reading a driver's license or other identification through use of the reader 22. This can be done by “swiping” the identification card having a magnetic stripe, utilizing optical character reading of the original identification credential, or the like. The client transaction station readers 28 are adapted for optical scanning and reading of bar codes, text or other images. Alternatively the master and client readers 22, 28 can be optical scanners or magnetic reader/writers or other devices that are adapted to read wirelessly transmitted signals emanating from devices on or embedded within the wristband 36 and to write information back to those devices, as will be discussed below. Keyboards, computer “mice,” voice recognition devices, and touch screen monitors can be used for manual data input either as the primary data input means or as a back up data input means for those instances when the automatic readers do not work.

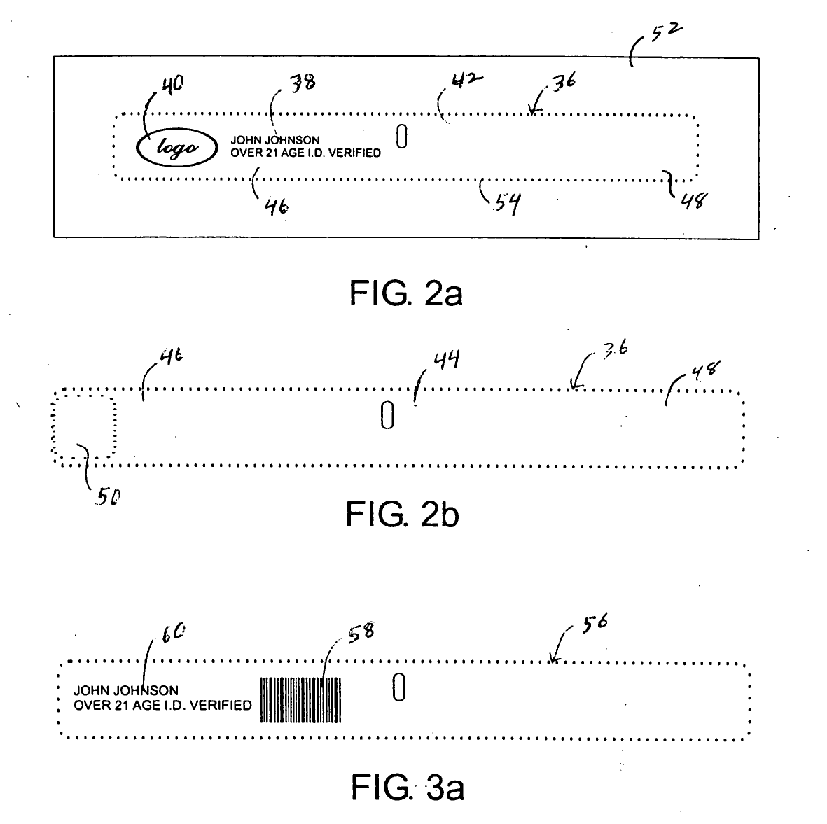

Referring to FIGS. 2a and 2b, the wristband 36 has a front surface 42 and a rear surface 44, and is adapted to be secured around the wrist of a user. The front surface 42 has information, such as text 38 (for identification and transaction authorization purposes) appearing on a first portion 46 of the band 36. Additionally, a logo 40 or other promotional matter may appear on the first portion 46. The band further has a second portion 48 that is left generally blank. An adhesive section 50 protected by a peel strip (not shown) is disposed on the rear surface 44 of the first portion 46 of the band 36. This permits the band 36 to wrap around the wrist of the user so that when the peel strip is removed, the adhesive section 50 adheres to the front surface 42 of the generally blank second portion 48 of the band 36 in a semi-permanent manner.

The printer 20 located at the master transaction station 12 places an image comprised of the text 38 and logo 40 or even a photograph, such as of the individual, on the wristband. The band 36 is part of a larger sheet 52 of material that is processed by the printer 20. Score or die cuts 54 are disposed in the sheet 52 thereby forming the shape of the band 36 and permitting the band to be separated from the sheet 52. In alternative embodiments, a sheet can contain a plurality of bands that can be simultaneously processed in one pass through the printer. On the other hand, there need not be any larger sheet. Rather, a band can be processed by a printer that is adapted to handle the dimensions of the band without the need for a larger sheet.

While the band 36 of FIGS. 2a and 2b has an adhesive section 50 for attachment of the ends of the band, it will be appreciated by those skilled in the art that other closure devices and means for attachment can be used, including for example, the use of security slits formed through the wristband. The slits can be formed either vertically or diagonally to define areas of weakness so that the wristband tears in these areas should attempts be made to forcefully separate the wristband when adhered to itself. Thus, a wristband that is torn along the security slits can be automatically invalidated and cannot thereafter be used. This can prevent persons from forcefully removing wristbands from other patrons and using the bands in an unauthorized manner.

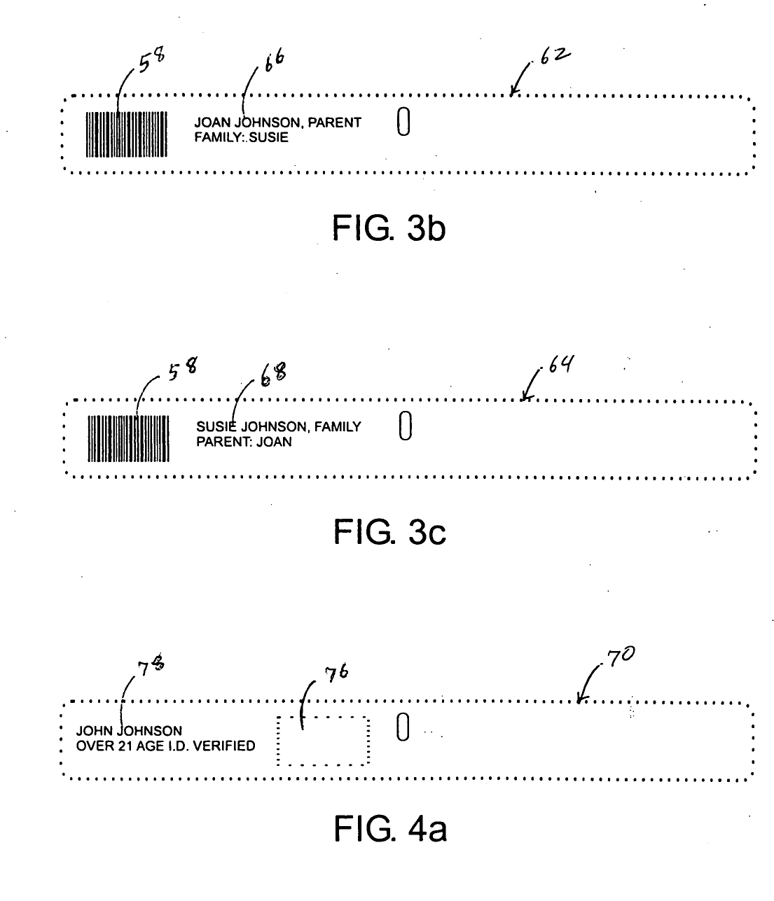

FIGS. 3a, 3b and 3c illustrate wristbands 56, 62, 64 having barcodes 58 printed thereon. The optical scanners 28 (FIG. 1) at the client transaction stations 14 can read the barcodes 58 for automated information input into the system 10. Additionally, printed text 60, 66, 68 is also placed on the bands for either back up or supplemental informational purposes.

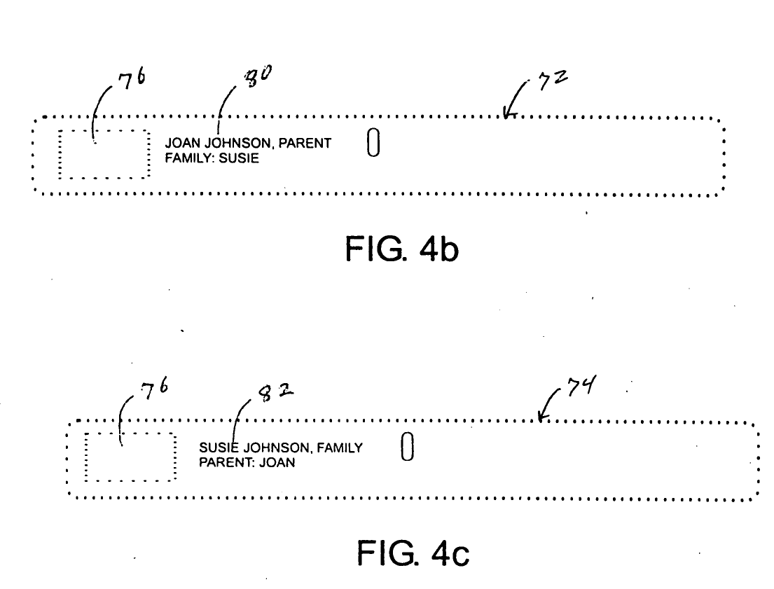

As shown in FIGS. 4a, 4b and 4c, the wristbands 70, 72, 74 preferably have radio frequency identification (RFID) devices 76 embedded therein. These devices can be passive, semi-active or active RFID formats, and can include RFID printed circuitry of various configurations, including but not limited to, conductive polymers and organic semiconductor devices. The RFID devices can communicate passively such as a transponder, or actively by initiating communications, or both. Because these devices can communicate wirelessly as part of the system 10 (FIG. 1) by sending data, receiving data, or both, a wristband with an RFID device can perform numerous functions, such as transmit information about the identification and location of the patron to another device. Various wristband constructions, attachments and other features including the storage of electronic data and RFID functions are described, for example, in Penuela U.S. Pat. No. 5,493,805, Mosher U.S. Pat. No. 5,457,906, Mosher U.S. Pat. No. 5,973,600, Beigel U.S. Pat. No. 5,973,598, Beigel U.S. Pat. No. 6,181,287, Peterson U.S. Pat. No. 5,479,797 and Peterson U.S. Pat. No. 5,581,924, the contents of which are incorporated herein.

The client transaction stations can include readers adapted to receive radio frequency signals emanating from the RFID devices 58 and containing information pertaining to the patron. This permits rapid and automated patron information to be entered into the system 10. Additionally, printed text 78, 80, 82 is also placed on the bands for either back up or supplemental informational purposes.

Thus according to one embodiment of the invention, a person having an identification device, such as for example a driver's license, containing a first set of data associated with the person presents the identification device at a first station located on a premises. The first set of data is inputted from the identification device into a computer database, and a new record that is associated with the person is created in the database. An information device, such as for example a wristband, is adapted to convey a second set of data associated with the person. Then the information device is provided to the person. When the person desires to conduct a transaction at a second station on the premises, the person presents the information device at the second station. The second set of data is next read from the information device, and at least a part of this data is used to determine whether a transaction criteria has been satisfied. Finally, the transaction with the person is permitted at the second station after determining that the transaction criteria has been satisfied. On the other hand if the transaction criteria has not been satisfied, then the transaction with the person is not permitted.

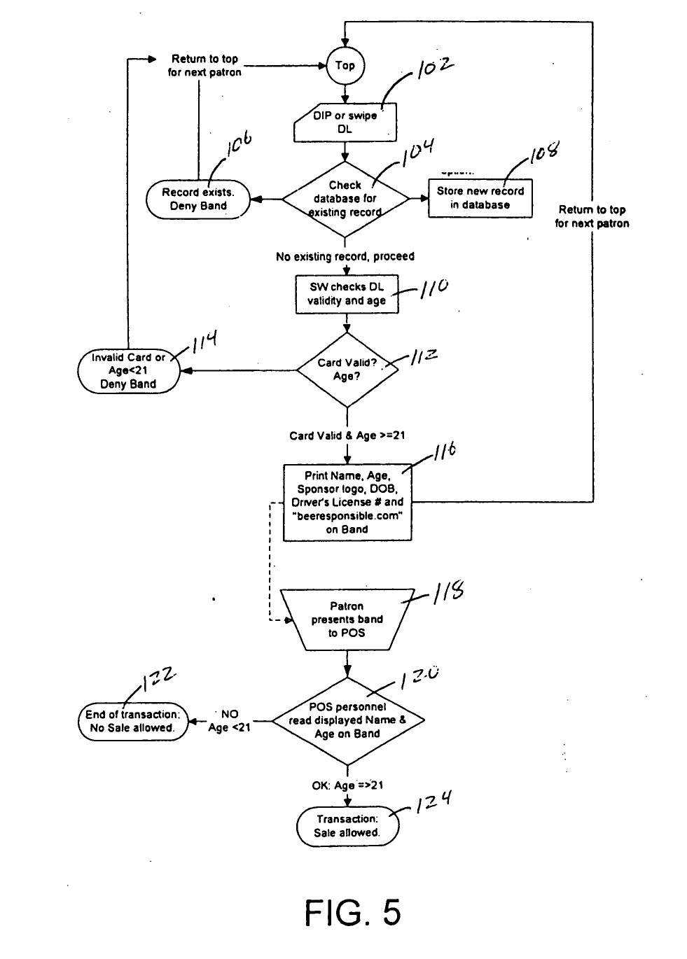

FIG. 5 shows a flow diagram for a method of authorizing the sales of alcoholic beverages according to another embodiment of the invention. The patron's driver's license or other identification device is swiped or read by a reader connected to a computer at a transaction station. 102. The reader extracts a set of data associated with the identification and other information about the patron and transmits that data to the computer. Alternatively, information is manually entered via a keyboard or other manual input device.

The information is checked against a database to determine if there is an existing record in the database associated with that patron. 104 If an existing record is found, then the proposed transaction is denied and a wristband will not be provided. 106 This can indicate that the patron has previously obtained a wristband and perhaps has had access to alcoholic beverages. On the other hand, if no existing record is found, then a new record is created for the patron and stored in the database 108, the validity of the driver's license or other device is checked and a calculation made as to the patron's age. 110

The validity of the driver's license can be determined by a comparison with data already stored in the local database or with data located in off-site databases, such as governmental agencies, credit bureaus or other organizations. Additionally or alternatively, the validity can be determined by a visual comparison of the physical attributes of the patron presenting the driver's license with the physical criteria appearing or encoded on the driver's license. A determination is made whether the license is valid and whether the patron meets the criteria for the transaction, such as whether the age is twenty one years or older. 112 If the age criteria or license validity tests are not met, then the transaction is denied and a band will not be provided. 114 On the other hand, if the driver's license is valid and if the age criteria is satisfied, then the transaction can proceed. The patron initially pays cash or authorizes a credit card payment. This payment information is recorded in the database to create an account having an account balance. Then a wristband is adapted to convey information or data associated with the patron. In this case, the wristband is processed by a printer that places an image or information on the band. 116

Information may be printed on the band and can include the patron's identification data, such as for example, name, address, date of birth, age criteria (e.g. an indication whether or not the age is twenty one years and older), sex, height, weight, hair color, eye color, and other biometric data. Additionally, the information can further include an indication as to whether or not a transaction is permissible, along with logos or other promotional information. The band is then presented to the patron or secured upon the body or clothing of the patron for use on the premises.

When the patron desires to conduct other transactions on the premises, such as for example, obtain an alcoholic beverage, the band is presented to a client transaction station, such as a POS station. 118 The operator of the transaction station visually reads the information appearing on the band and determines whether the transaction may be permitted based upon the information. 120 Also, if the band is constructed in such a manner as to provide an indication of tampering or transferring to another patron, the operator will visually check for such occurrences. If the transaction criteria is not met, such as for example, the information on the band shows that the patron's age is less than twenty one years, or if there is visual evidence of wrist band tampering or transference, then the transaction is denied to the patron. 122 On the other hand, if the criteria is met, then the transaction is allowed which in this case would mean that an alcoholic beverage is provided to the patron. 124

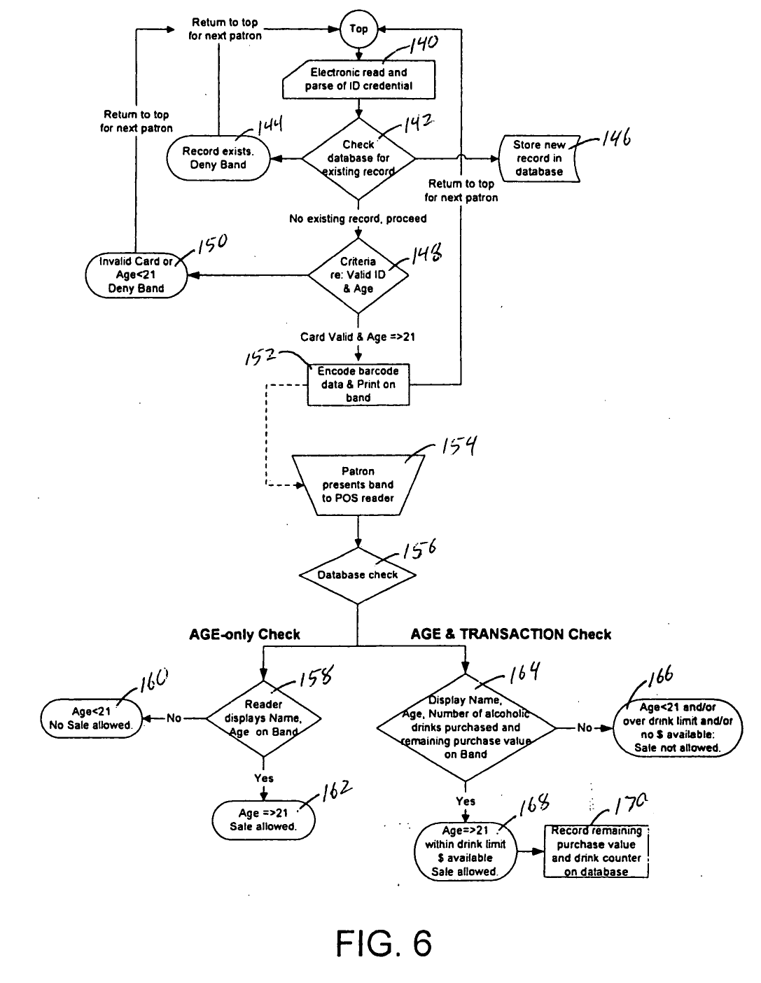

A method for authorizing the sale of an alcoholic beverage according to another embodiment of the invention is generally shown in the flow diagram of FIG. 6. The patron's driver's license or other identification device is swiped or otherwise read by a reader connected to a computer at a transaction station. 140 The reader automatically extracts identification and other information about the patron and transmits that information to the computer. Alternatively, information is manually entered.

The information is checked against a database to determine if there is an existing record in the database associated with that patron. 142 If an existing record is found, then the proposed transaction is denied and a wristband will not be provided. 144 On the other hand, if no existing record is found, then a new record is created for the patron and stored in the database 146, and the validity of the driver's license or other device is checked and a calculation made as to the patron's age.

The validity of the driver's license can be determined by a comparison with data already stored in the local database or with data located in off-site databases, such as governmental agencies, credit bureaus or other organizations. Additionally or alternatively, the validity can be determined by a visual comparison of the physical attributes of the patron presenting the driver's license with the physical criteria appearing or encoded on the driver's license. A determination is made whether the license is valid and whether the patron meets the criteria for the transaction, such as whether the age is twenty one years or older. 148 If the age criteria or license validity tests are not met, then the transaction is denied and a band will not be provided. 150

On the other hand, if the driver's license is valid and if the age criteria is satisfied, then the transaction is permitted to proceed. Additional information relating to this patron and future activities on the premises can next be stored in the database. Such additional information can include the date and time that the wristband is issued and the amount of any pre-payment of monies made by the patron for credit in subsequent purchases, etc. The wristband is then processed through a printer that places a barcode, and optionally, other information on the band. 152

The barcode or other information printed on the band can include the patron's identification data, such as for example, name, address, date of birth, age criteria (e.g. an indication of whether or not the age is twenty one years and older), sex, height, weight, hair color, eye color, and other biometric data. Additionally, the information can reveal whether or not a particular type of transaction is permissible, along with logos or other promotional information. The band is then presented to or secured upon the body or clothing of the patron for use on the premises.

When the patron desires to conduct a transaction on the premises, such as for example, obtain an alcoholic beverage, the band is presented to a client transaction station operator, such as a POS station operator. The operator reads (i.e., scans) the barcode on the band with an optical scanner. 154 At this point the database is queried 156 and a determination made whether the transaction is to be permitted based upon the patron information in the database record.

In those instances where the only transaction criteria is the age of the patron, then the transaction station display will show the name and age of the patron who presented the wristband and a statement or indication as to whether the transaction is to be permitted. 158 If the criteria is not met, such as if the patron's age has not reached twenty one years, then the transaction is denied and an alcoholic beverage will not be provided. 160 On the other hand, if the age criteria is met, such as if the patron's age is twenty one years or older, then the transaction is approved. 162

In those instances where there are more transaction criteria than simply the patron's age, then the transaction station display will show additional information, such as for example, the patron's name, age, number of alcoholic drinks previously purchased along with the date/time of each such purchase, and remaining purchase value or credit associated with the band. 164 If any one of the necessary criteria is not met, then the transaction is not allowed. 166. Such rejection criteria may include an indication that the patron's age is less than twenty one years, that an excessive quantity of drinks have already been purchased for a given time period (thus indicating a likely physical condition of intoxication), or that there is insufficient purchasing credit remaining on the patron's account. As before, additional rejection criteria can include a visual inspection of the band for evidence of tampering or transference. Where drinks are to be limited on the basis of the number of drinks to be provided over a given time period, the database can be programmed to permit a variable number of permitted drinks per time period for different patrons. Height, weight, sex, age, the type of beverage and other variables can be employed with alcohol consumption tables in order to calculate the blood-alcohol level that would result from a given quantity of different types of alcoholic beverages.

On the other hand, if all of the necessary criteria is met, then the transaction is allowed. 168 The database record for this patron is updated to record the date/time of the transaction and to debit the patron's account. 170 Should the patron desire to replenish his or her account, further cash or credit card payments can be made, either at the master transaction station or at a client station, whereupon the database record is updated to reflect an increased account balance. Alternatively, rather than using the database, some of this information can be manually monitored or controlled. For example, the wristband may include tear-off tabs for removal to count the number of purchases or to serve as a payment token.

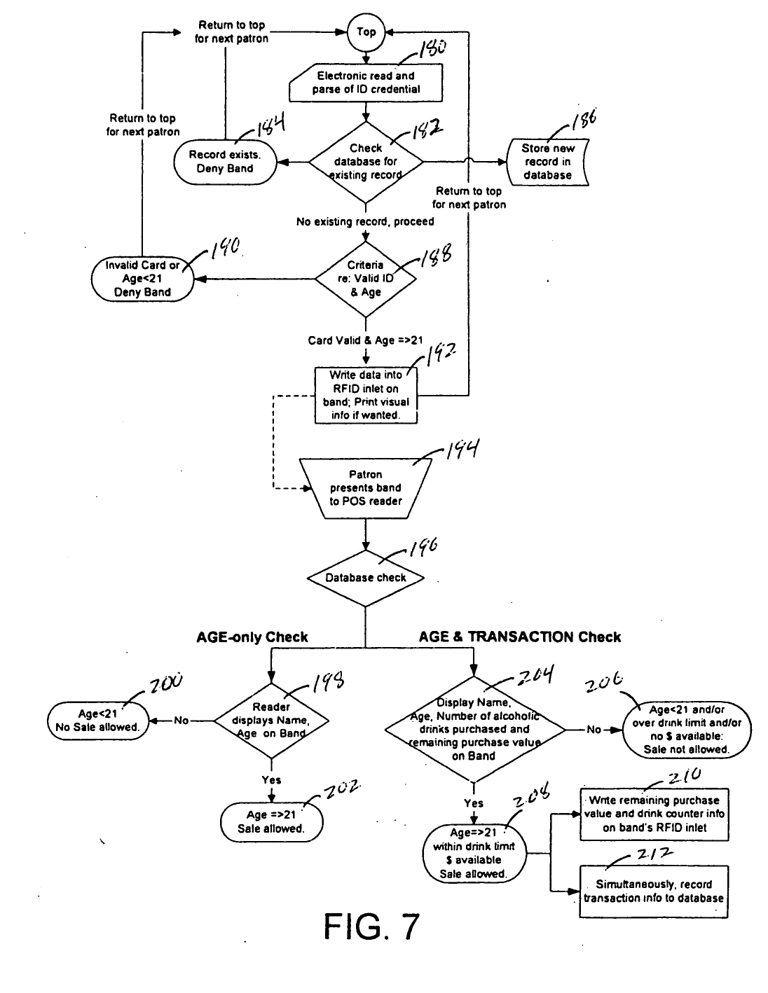

A method for authorizing the sale of an alcoholic beverage according to yet another embodiment of the invention is generally shown in the flow diagram of FIG. 7. As before, the patron's driver's license or other identification device is swiped or otherwise read by a reader connected to a computer at a transaction station. 180. The reader automatically extracts identification and other information about the patron and transmits that information to the computer. Alternatively, information is manually entered.

The information is checked against a database to determine if there is an existing record in the database associated with that patron. 182 If an existing record is found, then the proposed transaction is denied and a wristband will not be provided. 184 On the other hand, if no existing record is found, then a new record is created for the patron and stored in the database 186, the validity of the driver's license or other device is checked and a calculation made as to the patron's age.

The validity of the driver's license can be determined by a comparison with data already stored in the local database or with data located in off-site databases, such as governmental agencies, credit bureaus or other organizations. Additionally or alternatively, the validity can be determined by a visual comparison of the physical attributes of the patron presenting the driver's license with the physical criteria appearing or encoded on the driver's license. A determination is made whether the license is valid and whether the patron meets the criteria for the transaction, such as whether the age is twenty one years or older. 188 If the age criteria or license validity tests are not met, then the transaction is denied and a band will not be provided. 190

On the other hand, if the driver's license is valid and if the age criteria is satisfied, then the transaction is permitted to proceed. Additional information relating to this patron and his or her future activities on the premises can next be stored in the database. Such additional information can include the date and time that the wristband is issued and the amount of any pre-payment of monies made by the patron for credit in subsequent purchases, etc. Then a wristband is adapted to convey information/data associated with the patron. In this case, the wristband is processed by the transaction station computer that writes data to a radio frequency identification (RFID) device that is attached to or embedded within the band. Optionally, the wristband can also be processed through a printer that places a barcode and other visual information on the band. 192

The information written to the RFID on the band can include the patron's identification data, such as for example, name, address, date of birth, age criteria (e.g. an indication whether or not the age is twenty one years and older), sex, height, weight, hair color, eye color, iris pattern, retina pattern, deoxyribonucleic acid (DNA) profile, and other biometric data. Additionally, the information can reveal whether or not a particular type of transaction is permissible. Printed information can include any of the above, along with a photo, logos or other promotional information. The band is then presented to or secured upon the body or clothing of the patron for use on the premises.

When the patron desires to conduct a transaction, such as for example, to obtain an alcoholic beverage, the wristband is presented to a client transaction station operator, such as a POS station operator. The operator reads or scans the band with an RFID reader thereby allowing the client station to receive the information transmitted from the RFID device in the patron's band. 194 At this point, the database is queried 196 and a determination made whether the transaction is to be permitted based upon the patron information in the database record.

In those instances where the only transaction criteria is the age of the patron, then the transaction station display will show the name and age of the patron who presented the wristband and a statement or indication as to whether the transaction is to be allowed. 198. If the criteria is not met, such as if the patron's age is not twenty one years, then the transaction is denied. 200 On the other hand, if the age criteria is met, such as if the patron's age is twenty one years or older, then the transaction is approved. 202

In those instances where there are more transaction criteria than simply the patron's age, then the transaction station display will show additional information, such as for example, the patron's name, age, number of alcoholic drinks previously purchased along with the date/time of each such purchase, and remaining purchase value on the band. 204 If any one of the necessary criteria is not met, then the transaction is not allowed. 206. Such rejection criteria may include an indication that the patron's age is less than twenty one years, that an excessive quantity of drinks have already been purchased for a given time period (thus indicating a likely physical condition of intoxication), or that there is insufficient purchasing credit remaining on the patron's account. As before, additional rejection criteria can include a visual inspection of the band for evidence of tampering or transference. Where drinks are to be limited on the basis of the quantity of drinks over a given time period, the database can be programmed to permit a variable number of permitted drinks per time period for different patrons. Height, weight, sex, age, type of beverage and other variables can be employed with alcohol consumption tables in order to calculate the blood-alcohol level that would result from a given quantity of different types of alcoholic beverages.

On the other hand, if all of the necessary criteria is met, then the transaction is allowed. 208 Updated or additional information is written to the wristband RFID 210 from the client transaction station. Such information can include the amount and type of drinks purchased, the date and time of the purchase, and the amount of remaining purchase credit. The database located at the master transaction station is updated for this patron to record the date/time of the transaction and the type of beverage provided, and to debit the patron's account 212.

Alternatively, rather than using the database, some of this information can be manually monitored or controlled. For example, the wristband may include tear-off tabs for removal to count the number of purchases or to serve as a payment token.

As another alternative, the RFID is a read-write device wherein the reader reads the information, by wireless or contact communication, to determine the above-mentioned information. A computer display unit or the like can be associated with the reader such that information obtained from the RFID device is conveyed to the display unit. After the transaction, the RFID device's memory is altered such that the transaction is tracked within the RFID memory and not a separate database. Alternatively, the transactions may be accounted for in either or both the RFID device and the database. Thus, for example, when an alcoholic beverage is purchased, this transaction is accounted for by debiting the credits previously paid for or otherwise allotted to the wristband and thus the patron. The amounted debited can be represented as a “cash” amount, or a token or ticket amount wherein each beverage “costs” a predetermined number of tickets tokens.

Although the foregoing description has generally been directed to a system and method involving transactions for the providing of alcoholic beverages, it will be appreciated that the scope of the inventions disclosed herein is broader and includes many types of transactions. Additional transactions can include (a) the providing of food, non-alcoholic beverages, or articles of goods, and (b) allowing a person to play a game, to embark on an amusement ride, and to enter into or exit from a controlled area. Examples of controlled areas include a shower facility, a restroom facility, an amusement park, a water park, a sports arena, a casino, a concert venue, a shopping mall, a movie theater, an area within a hospital, an area within a prison facility, and an area within a jail facility.

Additionally, it will be appreciated that the scope of the invention further includes allowing for pre-payment of almost any type of service or item (in addition to beverages) provided on a premises thereby providing a “cashless” or “credit” transaction system. In addition to credit statistics, a database of other consumer purchasing statistics generated on the premises can be created. Also, a database can be employed as an automatic inventory control manager of goods sold or used.

Other embodiments of the invention address child/parent identification and pairing in public places or other premises. Examples include amusement parks, water parks, movie theaters, shopping malls, etc. This can help reduce occurrences of abduction of children by strangers and of children simply becoming lost due to separation from their parents in these places. A system can be configured to require two or more ID bands or other ID documents to be registered together in order to allow exit from the premises, thus discouraging kidnappers.

Pairs of ID bands for this purpose are illustrated in FIGS. 3b, 3c, 4b and 4c. Thus for example, upon entering the premises, the master transaction station 12 (FIG. 1) would generate the pair of bands 62, 64. One band 62 is attached to the parent and the other band 64 is attached to the child. Later upon preparing to exit the premises, the bands 62, 64 are again read. If the monitor at one of the stations does not show a “match” or otherwise indicate that the child is with the same person who accompanied the child when entering the premises, then at least the child is not permitted to exit without further investigation. Alternatively, neither the child nor the person accompanying the child is permitted to exit without further investigation.

In one embodiment of the invention, a record set of data is entered in a computer database. First and second information devices, such as for example wristbands, are adapted to convey a first and second set of data, respectively, after the step of entering the record set of data in the computer database. One example of this adaptation would be to print images onto wristbands by processing them through a printer.

Later at a point of egress from the premises, the first set of data is read from the first information device being carried by a child, and the second set of data is read from the second information device being carried by an adult. The first and second sets of data are compared with the record set of data. The child is permitted to exit the premises when the first and second sets of data correspond to the record set of data thereby indicating that the child and adult were in the company of one another during the steps of adapting the first and second information devices to convey the first and second sets of data. If the first and second sets of data do not correspond to the record set of data, then the child is not permitted to exit the premises without further investigation.

This pairing feature of the invention is not limited to parent/child pairs, but also could be used for any other desirable pairing or grouping of individuals, such as for example, Teacher/Student pairing, Person/Group pairing, Leader/Group pairing, Jailor/Inmate pairing (such as for use in the transporting of inmates by jailors), and so forth.

In another embodiment of the invention, the system can be configured with “locate” stations placed throughout the premises, where separated family members or separated members of any group can have their ID bands “read” and find one another at these stations with or without the assistance of the employees working there.

Thus, for example, first and second information devices, such as wristbands, are each adapted to convey a set of data. In one embodiment of the invention, this adaptation comprises using a printer to place a barcode representing the set of data on each of the wristbands. The set of data corresponds to a single, unique identification number that is automatically assigned to each of the pair of wristbands. The first and second wristbands are then provided to a parent and a child, respectively.

When the child becomes separated from the parent, and they are unable to locate one another, the parent proceeds to a first station that is at a first location on the premises and that is in communication with a central computer. The set of data is read from the first wristband at the first station. Similarly, the child proceeds to a second station that is at a second location on the premises and that is in communication with the central computer. The set of data is also read from the second wristband at the second station.

Then, the location on the premises of the second station is provided at the first station. For example, the first station may have a display screen that shows a map of the premises and the placement of the second station on the map. The parent could then determine from the map the location of the second station and the child.

In an alternative embodiment of the invention, a first set of data that is associated with a parent and a child is entered into a computer database. A first wristband is adapted to convey a second set of data associated with the parent, and a second wristband is adapted to convey a third set of data associated with the child. The first and second wristbands are then provided to the parent and child, respectively.

When the child becomes separated from the parent, and they are unable to locate one another, the parent proceeds to a first station that is at a first location on the premises and that is in communication with the computer database. The second set of data is read from the first wristband at the first station. Similarly, the child proceeds to a second station that is at a second location on the premises and that is in communication with the computer database. The third set of data is read from the wristband at the second station.

The second and third sets of data are compared with at least a part of the first set of data that is located in the database. Then, the location on the premises of the second station is provided at the first station when the second and third sets of data correspond to the at least a part of the first set of data. For example, the first station may have a display screen that shows a map of the premises and the placement of the second station on the map along with the name of the child or photograph of the child or parent displayed next to the second station. The parent could then determine from the map the location of the second station and the identity of the child.

While the foregoing describes a method and system whereby a parent, for example, can locate a child, it will be appreciated that the invention permits “two way” or multiple party location capabilities. That is, the child's wristband can be read at a station where the location of the parent at another station is displayed.

In another embodiment, each person in a group comprised of three or more persons may have a wristband. Each group member can have his or her wristband read at any one of several stations where there can be displayed the location of one or more of the other group members at one or more of the other stations, along with a display of the identity of each member located at each station. Additionally, the system can be configured to automatically display a suggested location where all group members should meet along with a suggested meeting time. This may be particularly helpful when three or more display stations simultaneously display the locations of three or more group members. Without such a feature, the group members may have difficulty in jointly determining which of the several stations or locations at which to meet or converge.

Still other embodiments of the present invention address a more general need for identification. There may be situations in public environments where correct patron identification is integral to the service, access or consumable offered, such as for example, weight limits on certain amusement park rides, male/female identification on entry doors at water park locker rooms, and so forth. The system can be configured to automatically identify the patron at such points in a more accurate, non-transferable, and faster manner than currently available with known systems.

In yet another embodiment of the present invention, information is obtained from the individual (such as age, height, sex, weight, address, billing information, etc.) and this information input into a digital file stored in a database or written into the RFID memory. When the individual presents the identification device, typically in the form of a wristband, the identification device is read and the information accessed through the database or transmitted from the RFID device to the reader. This device can be used by a computer program to fill out a necessary form, such as a medical form, automatically. It will be appreciated that this embodiment can also be used for non-medical uses, such as filling out a form at an airport, purchasing tickets, or other such uses where the information can be automatically obtained and presented in a format needed by the end user. It will be appreciated that such automatic conveyance of such information can save a tremendous amount of time in obtaining this information, sometimes repeatedly, and manually inputting the information into an electronic form or even a manual form.

While the description above was largely directed to the use of wristbands, other information devices, such as for example, bracelets, patches, headbands, neckbands, legbands, cards, stickers, tags, labels, or smart cards can be carried by, worn on, or attached to a person.

The system shown in FIG. 1 has one database 24 at the master transaction station 12. However in alternative embodiments, a plurality of databases may reside on or in each of the client transaction stations' readers 28 or computers 26. The information contained on or in the wristband 36 can be collected and stored at each client transaction station visited by the patron. Then the statistical or other information collected at each client transaction station is gathered at a later point in time for entry into a central database.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

1. A method of conducting a transaction with a person having an identification device containing a first set of data associated with the person, the method comprising:
presenting the identification device at a first station;
inputting the first set of data from the identification device into a computer database;
creating a new record in the database, said new record being associated with the person;
adapting an information device to convey a second set of data associated with the person;
providing the information device to the person;
reading the second set of data from the information device at a second station;
determining whether a transaction criteria has been satisfied by using at least a part of the second set of data; and
permitting a first transaction with the person at the second station after determining that the transaction criteria has been satisfied.

2. The method of claim 1 wherein the first transaction is one of providing food to the person, providing a beverage to the person, providing an article of goods to the person, permitting the person to play a game, permitting the person to embark on an amusement ride, permitting the person to enter into a controlled area, and permitting the person to exit from the controlled area.

3. The method of claim 2 wherein the controlled area is one of a shower facility, a restroom facility, an amusement park, a sports arena, a casino, a concert venue, a water park, a shopping mall, a movie theater, an area within a hospital, an area within a prison facility, and an area within a jail facility.

4. The method of claim 1 wherein the identification device is one of a driver's license, a credit card, a debit card, a smart card, a passport, a social security card, a voter registration card, an employee identification card, a student identification card, a military identification card, and an immigration card.

5. The method of claim 1 further comprising determining the validity of the identification device.

6. The method of claim 1 including the step of performing an optical character reading of at least a portion of the identification device.

7. The method of claim 5 wherein the step of adapting the information device occurs after determining that the identification device is valid.

8. The method of claim 1 wherein the new record is created after determining that a pre-existing record associated with the person does not exist in the database.

9. The method of claim 1 wherein the transaction criteria comprises a time period following a date of birth and wherein the first transaction is the providing of an alcoholic beverage to the person.

10. The method of claim 1 further comprising:
receiving a payment from the person; and
recording in the database the amount received from the person to create an account having an account balance.

11. The method of claim 10 wherein the first transaction has a cost associated with the first transaction, and wherein the transaction criteria comprises the account balance being in excess of the first transaction cost.

12. The method of claim 1 wherein the information device is one of a wristband, a bracelet, a patch, a headband, a neckband, a legband, a card, a sticker, a tag, a smart card and a label.

13. The method of claim 1 wherein at least a part of the second set of data appears as a barcode.

14. The method of claim 1 wherein the information device includes a radio frequency identification (RFID) device and wherein at least a part of the second set of data resides within the RFID device.

15. The method of claim 1 wherein the information device includes a radio frequency identification (RFID) device and wherein the step of adapting the information device further includes writing at least a part of the second set of data to the RFID device.

16. The method of claim 15, wherein the step of adapting information comprises the step of writing to a memory of the RFID device promotional value, points, or credits for redemption during a transaction.

17. The method of claim 1 wherein the information device is a wristband, the method further comprising securing the wristband about the wrist of the person.

18. The method of claim 1 wherein the information device is a wristband adapted to provide visible evidence of tampering of the wristband and wherein the transaction criteria comprises a lack of visible evidence of tampering of the wristband, the method further comprising visually observing the wristband for evidence of tampering.

19. The method of claim 1 wherein the first set of data from the identification device is inputted into the computer database using a manual input device.

20. The method of claim 1 wherein the step of reading the second set of data from the information device at the second station further comprises visually reading the second set of data by a second person, the method further comprising inputting the second set of data into the computer database using a manual input device.

21. The method of claim 1 wherein the identification device is a card having a magnetic stripe and wherein the first set of data from the identification device is inputted into the computer database using a reader adapted to extract the first set of data from the magnetic stripe.

22. The method of claim 1 wherein at least a part of the second set of data appears on the information device as a barcode and wherein the step of reading the second set of data from the information device at the second station further comprises optically scanning the barcode.

23. The method of claim 1 wherein the information device includes a radio frequency identification (RFID) device, wherein at least a part of the second set of data resides within the RFID device, and wherein the step of reading the second set of data from the information device at the second station comprises receiving radio frequency signals from the RFID device.

24. The method of claim 1 wherein the first set of data associated with the person comprises data associated with one of the person's age, name, sex, height, weight, date of birth, hair color, eye color, fingerprint, knuckle print, palm print, deoxyribonucleic acid (DNA) profile, iris pattern, and retina pattern.

25. The method of claim 1 further comprising inputting a third set of data associated with the first transaction into the computer database.

26. The method of claim 25 wherein the third set of data comprises one of the date of the first transaction, the time of the first transaction, and the cost associated with the transaction.

27. The method of claim 25 wherein the third set of data comprises one of the date of the first transaction and the time of the first transaction, the method further comprising:
reading the second set of data from the information device at a third station;
determining whether the transaction criteria has been satisfied by using at least a part of the second and third sets of data, wherein said criteria comprises a maximum number of transactions involving the person over a period of time; and
permitting a second transaction with the person at the third station after determining that the transaction criteria has been satisfied.

28. The method of claim 27 wherein the transactions involve the providing of alcoholic beverages and the criteria involves a maximum number of alcoholic beverages being provided to the person over the period of time.

29. The method of claim 1 wherein the step of adapting the information device further comprises using a printer to print an image on the information device, said printer being in communication with a computer.

30. A method of controlling the distribution of alcohol to a person having an identification device containing a first set of data associated with the person, the method comprising:
presenting the identification device at a first station;
inputting the first set of data from the identification device into a computer database;
determining whether a pre-existing record associated with the person exists in the database;
creating a new record associated with the person in the database after determining that no pre-existing record exists in the database;
inputting a payment amount received from the person into the database to create an account having an account balance;
adapting a wristband to convey a second set of data associated with the person, comprising the step of using a printer in communication with a computer to print an image on the wristband, said image being associated with at least a part of the second set of data;
securing the wristband on the wrist of the person;
presenting the wristband to a second station;
reading at least a portion of the second set of data from the wristband with an automatic reader at a second station, said reader being in communication with the database;
using at least a portion of the second set of data to determine whether the person satisfies an age criteria;
providing the alcohol having a cost to the person after determining that the person satisfies the age criteria and that the cost of the alcohol does not exceed the account balance; and
inputting a third set of data into the database, said third set of data being associated with the providing of the alcohol to the person.

31. A method of controlling the exit of a first person from a premises, the method comprising:
entering a record set of data in a computer database;
adapting a first information device to convey a first set of data after the step of entering the record set of data in the computer database;
adapting a second information device to convey a second set of data after the step of entering the record set of data in the computer database;
reading the first set of data from the first information device being carried by the first person;
reading the second set of data from the second information device being carried by a second person;
comparing the first and second sets of data with the record set of data; and
permitting the first person to exit the premises when the first and second sets of data correspond to the record set of data thereby indicating that the first and second persons were in the company of one another during the steps of adapting the first and second information devices to convey the first and second sets of data.

32. The method of claim 31 wherein the first and second information devices are each one of a wristband, a bracelet, a patch, a headband, a neckband, a legband, a card, a sticker, a tag, a smart card and a label.

33. The method of claim 31 wherein the first and second information devices each includes a first and a second radio frequency identification (RFID) device, respectively, and wherein the step of adapting the first information device further includes writing the first set of data to the first RFID device, and wherein the step of adapting the second information device further includes writing the second set of data to the second RFID device.

34. The method of claim 31 wherein each of the first and second information devices is a wristband, wherein the step of adapting the first information device further comprises using a printer to print a first image on the first information device, said first image being associated with the first set of data, and wherein the step of adapting the second information device further comprises using the printer to print a second image on the second information device, said second image being associated with the second set of data, said printer being in communication with a computer.

35. A method for permitting a first person to locate a second person in a premises, the method comprising:
adapting a first information device and a second information device each to convey a set of data;
providing the first information device to the first person and the second information device to the second person;
reading the set of data from the first information device at a first station disposed at a first location on the premises, said first station being in communication with a central computer;
reading the set of data from the second information device at a second station disposed at a second location on the premises, said second station being in communication with the central computer; and
providing at the first station, the location on the premises of the second station after completion of the steps of reading the set of data from the first and second information devices.

36. The method of claim 35 wherein the first and second information devices are each one of a wristband, a bracelet, a patch, a headband, a neckband, a legband, a card, a sticker, a tag, a smart card and a label.

37. The method of claim 35 wherein each of the first and second information devices includes a first and a second radio frequency identification (RFID) device, respectively, and wherein the step of adapting the first and the second information devices further comprises writing the set of data to each of the first and second RFID devices.

38. The method of claim 35 wherein each of the first and second information devices is a wristband, and wherein the step of adapting the first and second information devices further comprises using a printer to print an image on each of the first and second information devices, said image being associated with the set of data, said printer being in communication with a computer.

39. The method of claim 35, wherein the first and second information devices comprise wristbands, and wherein the first and second data comprises a photograph of each of the wearers of the first and second wristbands.

40. The method of claim 39, wherein the first and second information devices include RFID circuitry, and wherein the photograph of each of the wearers of the wristbands is either stored in the RFID circuitry or a database of the central computer.

41. A method for permitting a first person to locate a second person in a premises, the method comprising:
inputting a first set of data into a computer database, said first set of data being associated with the first and second persons;
adapting a first information device to convey a second set of data associated with the first person;
adapting a second information device to convey a third set of data associated with the second person;
providing the first information device to the first person and the second information device to the second person;
reading the second set of data from the first information device at a first station disposed at a first location on the premises, said first station being in communication with the computer database;
reading the third set of data from the second information device at a second station disposed at a second location on the premises, said second station being in communication with the computer database;
comparing the second and third sets of data with at least a part of the first set of data; and
providing at the first station, the location on the premises of the second station when the second and third sets of data correspond to the at least a part of the first set of data.

42. The method of claim 41 wherein the first and second information devices are each one of a wristband, a bracelet, a patch, a headband, a neckband, a legband, a card, a sticker, a tag, a smart card and a label.

43. The method of claim 41 wherein each of the first and second information devices includes a first and a second radio frequency identification (RFID) device, respectively, and wherein the step of adapting the first information device further comprises writing the second set of data to the first RFID device, and wherein the step of adapting the second information device further comprises writing the third set of data to the second RFID device.

44. The method of claim 41 wherein each of the first and second information devices is a wristband, and wherein the step of adapting the first information device further comprises using a printer to print a first image on the first information device, said first image being associated with the second set of data, and wherein the step of adapting the second information device further comprises using the printer to print a second image on the second information device, said second image being associated with the third set of data, said printer being in communication with a computer.

45. A system for use with a wristband and for controlling the distribution of alcohol having a cost to a person having an identification device containing a first set of data associated with the person, the system comprising:
a database;
a master station processing unit capable of communicating with the database;
a master station reader adapted to read the first set of data from the identification device, said reader being in communication with the master station processing unit;
a printer in communication with the master station processing unit and adapted to print an image on the wristband;
a client station processing unit capable of communicating with the master station processing unit;
a client station reader adapted to read the image from the wristband, said client station reader being in communication with the client station processing unit; and
program logic executed by the master station processing unit, comprising:
means for inputting the first set of data from the reader into the database;
means for inputting a payment amount received from the person into the database to create an account having an account balance;
means for causing the printer to print the image on the wristband, said image corresponding to a second set of data associated with the person;
means for using at least a portion of the second set of data to determine whether the person satisfies an age criteria;
means for determining whether the cost of the alcohol exceeds the account balance; and
means for inputting a third set of data into the database, said third set of data being associated with the cost of the alcohol and with the date and time that alcohol was provided to the person.

46. A method of controlling the distribution of alcohol to a person having an identification device containing a first set of data associated with the person, the method comprising:
presenting the identification device at a first station;
inputting the first set of data from the identification device into a computer database;
determining whether a pre-existing record associated with the person exists in the database;
creating a new record associated with the person in the database after determining that no pre-existing record exists in the database;
adapting a wristband having RFID circuitry to convey a second set of data associated with the person, comprising the step of using a printer in communication with a computer to print an image on the wristband, said image being associated with at least a part of the second set of data;
inputting a payment amount received from the person into a memory of the RFID circuitry to create an account having an account balance;
securing the wristband on the wrist of the person;
presenting the wristband to a second station;
reading at least a portion of the second set of data from the wristband with an automatic reader at a second station;
using at least a portion of the second set of data to determine whether the person satisfies an age criteria;
providing the alcohol having a cost to the person after determining that the person satisfies the age criteria and that the cost of the alcohol does not exceed the account balance; and
debiting the account balance of the RFID wristband.

47. The method of claim 46, wherein the first set of data is written into the RFID circuitry, and wherein the reader at the second station is associated with a display unit for displaying at least a portion of the first set of data obtained from the RFID wristband or database.

48. The method of claim 46, wherein the first set of data includes a photograph of the person.

49. A method for at least partially filling out an existing electronic form, comprising the steps of:
presenting an identification device;
electronically reading the identification device to acquire a set of information regarding the holder of the identification device;
extracting at least some information from the acquired set of information; and
at least partially electronically filling out the existing electronic form using the extracted information.

50. The method of claim 49, wherein the existing electronic form comprises a medical form.

51. The method of claim 49, wherein the extracted information is one of name, sex, age, height, and weight.

52. The method of claim 51, wherein the extracted information further includes at least one of address, billing information, and insurance.
